(19) United States
(12) Patent Application Publication
(10) Pub. No.: US 2009/0183988 A1
(43) Pub. Date: Jul. 23, 2009

(54) GAS SENSING ELEMENT AND GAS SENSOR USING SUCH GAS SENSING ELEMENT

(75) Inventor: Hirokatsu Imagawa, Ichinomiya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/354,895

(22) Filed: Jan. 16, 2009

(30) Foreign Application Priority Data
Jan. 17, 2008 (JP) 2008-008351
Nov. 5, 2008 (JP) 2008-284708

(51) Int. Cl. G01N 27/26

(52) U.S. Cl. 204/424

(57) ABSTRACT

A gas sensing element and a gas sensor using such a gas sensing element are disclosed. The gas sensing element includes a ceramic substrate having a surface on which electrode pads are provided to be brought into contact with abutment portions formed on contact terminals connected to external leads. The electrode pads are made of mixed material containing noble metal and ceramics. The electrode pads have surface regions, available to be held in contact with the contact terminals, each of which has a noble metal content greater than that of each of bonding regions of the electrode pads tightly bonded to the ceramic substrate.

### CROSS REFERENCE TO RELATED APPLICATIONS

This application is based on Japanese Patent Application Nos. 2008-8351, filed on Jan. 17, 2008, and 2008-284708, filed on Nov. 5, 2008, the contents of which are hereby incorporated by reference.

### BACKGROUND OF THE INVENTION

1. Technical Field of the Invention

The present invention relates to a gas sensing element for detecting specified gas concentration in measuring gases and a gas sensor using such a gas sensing element.

2. Description of the Related Art

In general practice, an attempt has heretofore been made to provide a gas sensor mounted on an exhaust system of an automotive vehicle for detecting a specified gas concentration such as an oxygen concentration or NOx concentration of exhaust gases. The gas sensor incorporates therein a gas sensing element employing a solid electrolyte such as zirconia or the like.

With the gas sensing element, the solid electrolyte has one and the other surfaces formed with a pair of measuring electrodes, respectively. A ceramic substrate of the gas sensing element, involving such a solid electrolyte, has a surface formed with electrode pads electrically connected to the pair of measuring electrodes, respectively (see Patent Publication 1: Japanese Patent Application Publication No. 2007-101387).

The electrode pads are adapted to be brought into contact with contact terminals of external leads for electrical connection thereto. That is, the gas sensing element performs an operation in exchange of signals between the electrode pads and an external control circuit via external leads. The contact terminals, having elastic forces, are held in elastic contact with the electrode pads with the contact terminals being urged in directions toward the electrode pads.

Further, there exists likelihood that a heater is unitized with the gas sensing element for adjusting a temperature the solid electrolyte. With such likelihood, the gas sensing element takes the form of a structure in that the gas sensing element has the surface formed with electrode pads, serving as electrodes of the heater, which are adapted to be brought into contact with contact terminals of external leads.

With the gas sensing element of the related art set forth above, however, the abutment contact segments formed on the contact terminals in the convexed shapes slide on the surfaces of the electrode pads when the contact terminals of the external leads are brought into contact with the electrode pads. When this takes place, the electrode pads are damaged and, in some case, there is a risk of the pealing of the electrode pads or the scraping of the same.

As a result, a risk arises with the occurrence of a difficulty of ensuring the electrode pads to have adequate connecting reliability.

### SUMMARY OF THE INVENTION

The present invention has been completed with a view to addressing the above issues and has an object to provide a gas sensing element having electrode pads with excellent connecting reliability and a gas sensor using such a gas sensing element.

(First Aspect of the Invention)

To achieve the above object, a first aspect of the present invention provides a gas sensing element comprising: a ceramic substrate; electrode pads formed on the ceramic substrate on one surface thereof and adapted to be brought into abutting contact with contact terminals on abutment portions formed thereon in convexed shapes, respectively, for electrical connections thereto; each of the electrode pads being made of mixed material including noble metal and ceramics; and the electrode pads having bonding regions tightly bonded to the surface of the ceramic substrate and surface regions providing surfaces available to be brought into contact with the contact terminals, respectively, wherein the surface regions are at least partially composed of a noble metal and have a greater noble metal content than that in the bonding regions.

Such a gas sensing element has various advantageous effects as described below.

With such a gas sensing element, each of the electrode pads includes the surface region having noble metal content greater than that of the bonding region. This enables the surface region to have an increased noble metal content with a resultant increase in smoothing property of a surface in contact with the contact terminal. Therefore, this is reflected in a decrease in a frictional force between the contact terminal and the electrode pad. This enables the suppression of damage to the electrode pad when the contact terminal is caused to slide on the surface of the electrode pad.

Further, with the surface region having noble metal content greater than that of the bonding region, the bonding region can have an increasing ceramic content. Therefore, the ceramic component of the bonding region is caused to bond to the ceramic component of the ceramic substrate, enabling an increase in a tight bonding force between the electrode pad and the ceramic substrate. Therefore, the electrode pad cannot be peeled off from the ceramic substrate when the contact terminal is caused to slide on the surface of the electrode pad.

As a result, this results in an increase in connecting reliability between the electrode pad and the contact terminal.

As set forth above, the present invention makes it possible to provide a gas sensing element having electrode pads each with excellent connecting reliability.

A reference invention provides a gas sensing element provided with electrode pads, operative to be brought into contact with contact terminals of external leads for electrical connection, each of which is made of mixed material containing noble metal and glass component.

The gas sensing element of the reference invention has advantageous effects as described below.

With the gas sensing element set forth above, the electrode pads are made of mixed material containing noble metal and glass component. That is, the electrode pads contain glass component. This enables the electrode pads to have increased sintering strengths with an increase in hardness. Therefore, no damage occurs on the electrode pads even when the contact terminals are caused to slide on the surface of the electrode pads.

As a result, the electrode pads can have increased connecting reliability for electrical connection to the contact terminals.

As set forth above, the reference invention makes it possible to provide a gas sensing element having electrode pads with excellent connecting reliability.

A second aspect of the present invention provides a gas sensor incorporating the gas sensing element of the first aspect of the present invention.

With the second aspect of the present invention, the gas sensor can be provided having the gas sensing element with the electrode pads having excellent connecting reliability.

With the first aspect of the present invention, examples of the gas sensing element may include various applications such as, for instance, an A/F sensor installed on exhaust pipes of various internal combustion engines like automotive engines for measuring an air/fuel ratio in response to a critical current value depending on a concentration of oxygen contained in measuring gases such as exhaust gases, an oxygen sensor for measuring a concentration of oxygen contained in measuring gases, and a NOx sensor used in detecting deterioration of a three-way catalyst installed on an exhaust pipe for checking a concentration of air contaminant such as NOx or the like.

Further, it will be appreciated that the gas sensing element of the present invention is described below as having one end, referred to a “leading end” or “leading end portion” adapted to be inserted to an inside of an exhaust system, and the other end referred to as “a base end” or “base end portion”.

With the first aspect of the present invention, the gas sensing element may include the surface region and the bonding region between which another layer is intervened having a composition different in noble metal content from those of the surface region and the bonding region. Alternatively, the surface region and the bonding region may be held in direct contact with each other. In addition, each of the electrode pads may take the form of a gradation structure in which noble metal content gradually varies in a thickness direction.

With the gas sensing element, furthermore, the electrode pads may preferably have layered structures each having two or more layers having the contents of noble metal in amounts different from each other, and each of the electrode pads may preferably have the uppermost layer, involving the surface region, and a lowermost layer, involving the bonding region, wherein the uppermost layer has noble metal content greater than that of the lowermost layer.

With such a structure, the surface region of the gas sensing element can have noble metal content greater than that of the bonding region in a further easy and reliable manner, enabling the electrode pads to have connecting reliability increased in a further easy and reliable manner.

With the gas sensing element of the present embodiment, the uppermost layer may preferably have a thickness of 4 μm or more and the lowermost layer may preferably have a thickness of 12 μm or more.

With such a structure, the electrode pads can have increased strengths in a further effective fashion. That is, allowing the uppermost layer to have the thickness of 4 μm or more adequately ensures smoothing properties of the surfaces of the electrode pads, enabling a reduction in frictional resistance with the contact terminals. In addition, with the lowermost layer having the thickness of 12 μm or more, the gas sensing element can ensure adequate bonding forces between the electrode pads and the ceramic substrate, while effectively enabling the suppression of peeling of the electrode pads.

With the gas sensing element of the present embodiment, noble metal may preferably include platinum and the ceramics includes alumina.

With such a structure, the electrode pads can have adequately increased electrical conductivities, while ensuring adequate tight bonding capabilities between the electrode pads and the ceramic substrate.

Moreover, examples of noble metal may further include, in addition to platinum (Pt), for instance, palladium (Pd), silver (Ag) and rhodium (Rh), etc. Also, noble metal may take the form of a mixture containing two or more kinds of these metals. Further, examples of ceramics may include, in addition to alumina (Al₂O₃), for instance, zirconia (ZrO₂) or the like. Also, ceramics may take the form of a mixture containing more than two kinds of ceramics.

With the gas sensing element of the present embodiment, the surface region may preferably have 1 wt % or less of ceramics by weight based on noble metal and the bonding region may preferably have 30 wt % or less of ceramics by weight based on noble metal.

With such a structure, the gas sensing element can have adequately increased strengths.

If the surface region contains more than 1 wt % of ceramics by weight based on noble metal, a difficulty is encountered in adequately ensuring smoothing properties of the surfaces of the electrode pads, causing a risk to arise with the occurrence of the scraping of the electrode pads due to friction with the contact terminals.

Further, if the bonding region has more than 30 wt % of ceramics by weight based on noble metal, there is a risk of a difficulty caused in obtaining the electrode pads having adequate electrical conductivities.

With the gas sensing element of the present embodiment, the bonding region may preferably have 12 to 30 wt % of ceramics by weight based on noble metal.

With such a structure, the electrode pads can be bonded to the ceramic substrate with increased bonding strengths in a further effective fashion, while ensuring adequate electrical conductivities of the electrode pads.

With the reference invention, the electrode pads may preferably have 0.1 wt % or more of the glass component by weight based on noble metal.

With such a structure, the electrode pads can effectively have increased sintering strengths with increased hardness.

If the glass component is less than 0.1 wt % by weight, the electrode pads are likely to have adequately improved sintering strengths and hardness.

With the reference invention, further, the electrode pads may preferably have a thickness of 12 μm or more.

In this case, the electrode pads can have adequate strengths.

If the thickness of the electrode pad is less than 12 μm, a drop occurs in strength of the electrode pad.

### BRIEF DESCRIPTION OF THE DRAWINGS

These and other features and advantages of the present invention will become more apparent in light of the following description, as illustrated in the accompanying drawings, in which:

FIG. 1 is a cross-sectional view showing a gas sensing element of an embodiment according to the present invention.

FIG. 2 is a perspective view of the gas sensing element of the embodiment shown in FIG. 1.

FIG. 3 is a longitudinal cross-sectional view showing a gas sensor incorporating the gas sensing element of the embodiment shown in FIG. 1.

FIGS. 4A to 4C are cross-sectional views illustrating how a scraping test is conducted on the gas sensing element of the embodiment shown in FIG. 1.

FIG. 5 is a graph showing results on the scraping test conducted on the gas sensing element of the embodiment shown in FIG. 1.

FIG. 6 is a cross-sectional view of an electrode pad of a gas sensing element of a reference example.

### DETAILED DESCRIPTION OF PREFERRED EMBODIMENTS

Now, a gas sensing element of an embodiment according to the present invention will be described below in detail with reference to the accompanying drawings. However, the present invention is construed not to be limited to such an embodiment described below and technical concepts of the present invention may be implemented in combination with other known technologies or the other technology having functions equivalent to such known technologies.

In the following description, it is to be understood that such terms as “leading end”, “base end”, “uppermost”, “lowermost”, “surface” and “region” and the like are words of convenience and are not to be construed as limiting terms.

### Embodiment

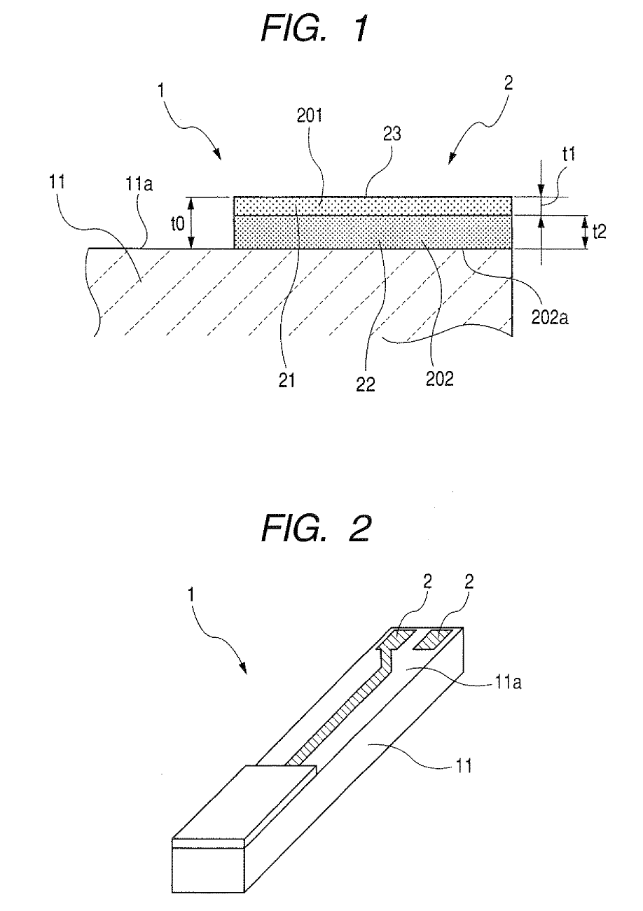

A gas sensing element of an embodiment according to the present invention will be described below in detail with reference to FIGS. 1 to 3 of the accompanying drawings.

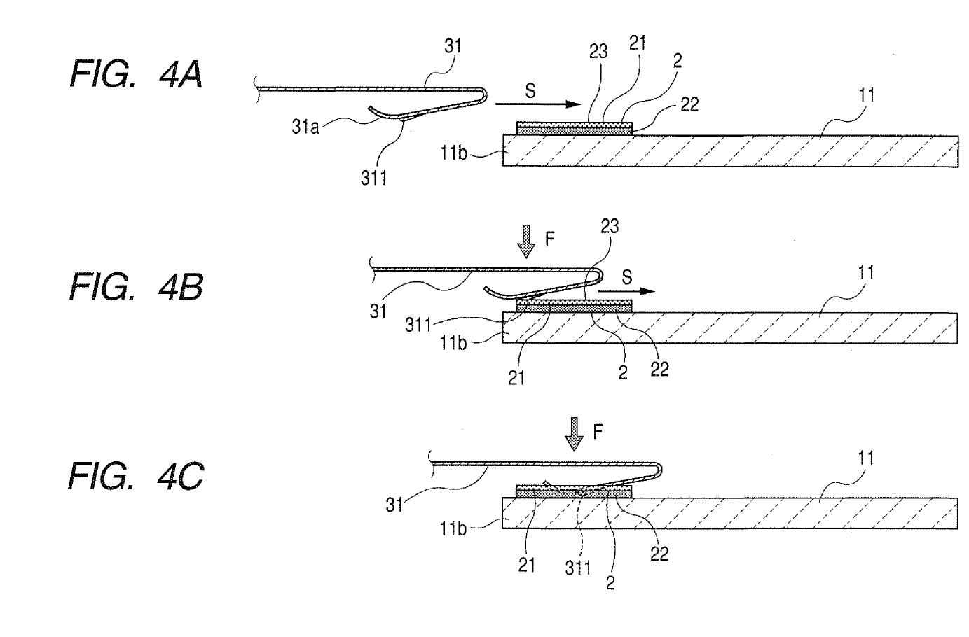

As shown in FIG. 1, the gas sensing element 1 of the present embodiment includes a ceramic substrate 11 that has a surface 11a on which electrode pads 2 are provided. The gas sensing element 1 is electrically connected to contact terminals 31 of external leads 3 of a gas sensor 4 to be applied with electrical power therefrom. Each of the contact terminals 31 has a contact portion 31a in the form of a folded spring end. The contact portion 31a has an abutment portion 311 (see FIGS. 4A to 4C), formed in a convexed shape protruding from the other area and extending in a direction parallel to a longitudinal direction of the gas sensing element 1, which is brought into electrical contact with each of the electrode pads 2 formed on the ceramic substrate 11 for electrical connection.

Each of the electrode pads 2 is made of mixed material containing noble metal and ceramic.

As shown in FIG. 1, further, the electrode pad 2 includes a surface region 201 and a bonding region 202 formed in two layers. The surface region 201 has contact surfaces 23 available to be brought into contact with the contact terminals 31 and the bonding region 202 has a bonding surface 202a held in tight contact with the surface 11a of the ceramic substrate 11. The surface region 201 has a noble metal content higher than that of the bonding region 202.

The electrode pad 2 takes the form of a layered structure with two or more layers different in noble metal content. In particular, the electrode pad 2 has an uppermost layer 21, covering the surface region 201, which has a noble metal content higher than that of a lowermost layer 22 covering the bonding region 202. With the gas sensing element 1 of the present embodiment, the electrode pad 2 is comprised of two layers with the uppermost layer 21 and the lowermost layer 22.

The uppermost layer 21 has a thickness t1 of 3 μm or more and preferably 4 μm or more. The lowermost layer 22 has a thickness t2 of 12 μm or more. In addition, the electrode pad 2 has a total thickness to in a range from 16 to 30 μm.

Further, examples of noble metal and ceramics, forming the electrode pad 2, include platinum (Pt) and alumina (Al₂O₃).

Furthermore, the surface region 201 contains 1% or more of ceramics by weight based on noble metal. The bonding region 202 contains 30% or less of ceramics by weight based on noble metal and more preferably in a value ranging from 12 to 30% by weight.

As shown in FIG. 2, the gas sensing element 1 includes the ceramic substrate 11, formed in a plate-like bar shape, which is composed of a solid electrolyte body having an oxygen ion conductivity. The solid electrolyte body has one surface and the other surface formed with measuring electrodes in a pair, respectively. One of the measuring electrodes in the pair is exposed to measuring gases and the other surface is exposed to reference gas such as atmospheric air or the like. These measuring electrodes are formed on the gas sensing element 1 in areas close proximity to a distal end thereof.

Moreover, the ceramic substrate 11 is formed of the solid electrolyte body, having a principal composition of zirconia (ZrO₂), on which an alumina layer is stacked having a principal component of alumina. The electrode pads 2, electrically connected to the pair of measuring electrodes mentioned above, are formed on a surface of the alumina layer, constituting the surface 11a of the ceramic substrate 11, at a base end portion of the gas sensing element 1.

Further, a heater is unitarily stacked on the ceramic substrate 11 for regulating a temperature of the gas sensing element 1 and has a pair of electrodes electrically connected to the electrode pads 2 that are formed on the surface 11a of the ceramic substrate 11 at the base portion thereof.

That is, the ceramic substrate 11 has the one surface 11a carrying thereon the pair of electrode pads 2 electrically connected to the pair of measuring electrodes, respectively, and the other surface also carries thereon the electrode pads electrically connected to the heater.

Each of a total of four electrode pads 2 is formed of materials set forth above.

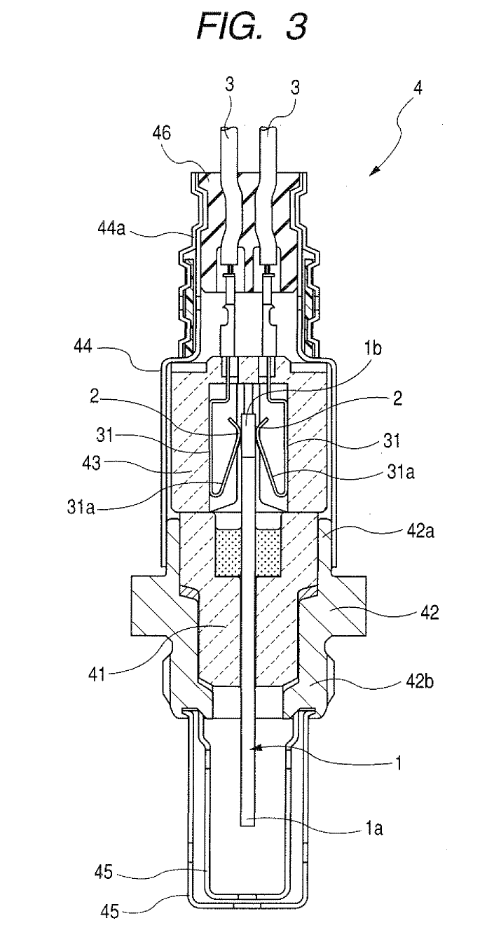

Further, the gas sensing element 1 is assembled into a gas sensor 4 shown in FIG. 3 for use.

That is, the gas sensor 4 includes the gas sensing element 1, an element holding porcelain insulator 41 holding the gas sensing element 1 in a fixed position, a housing 42 internally holding the element holding porcelain insulator 41, an atmospheric-side porcelain insulator 43 supported with the element holding porcelain insulator 41 at a leading end thereof so as to cover the same, and an atmospheric-side cover 44 fixedly mounted on the housing 42 at a base end 42a thereof. In addition, the housing 42 has a distal end portion 42b with which an element cover 45 is fixedly supported so as to cover a leading end portion 1a of the gas sensing element 1.

Further, the atmospheric-side cover 44 has a base end portion 44a with which a rubber bush 46 is fixedly retained to tightly close the base end portion 44a of the atmospheric-side cover 44. The rubber bush 46 has four axially extending through-bores through which four external leads 3 extend. The external leads 3 are electrically connected to four contact terminals 31 disposed inside of the atmospheric-side insulating porcelain 43, respectively. The contact terminals 31 comprise spring terminals having folded spring end portions 31a placed in two pairs in face-to-face relations to each other in urging effects. A base end portion 1b of the gas sensing element 1 is pinched between the pairs of contact terminals 31. In addition, the contact terminals 31 are held in pressured contact with the electrode pads 2 of the gas sensing element 1, respectively, due to elastic forces of the contact terminals 31.

An urging force with which the contact terminal 31 is held in pressured contact with the electrode pad 2 is selected to lie at a large magnitude to prevent the contact terminal 31 from disengaging from the electrode pad 2 due to vibrations or the like of a vehicle, i.e., a magnitude of, for instance, 4 to 10 N.

In manufacturing the gas sensor 4, the base end portion 1b of the gas sensing element 1 is inserted between the two pairs of the contact terminals 31. That is, the gas sensing element 1 extends through and supported with the element holding porcelain insulator 41 placed inside of the housing 42, under which the base end portion 1b of the gas sensing element 1 is inserted between the two pairs of the contact terminals 31 retained inside of the atmospheric-side porcelain insulator 43. When this takes place, the two pairs of the contact terminals 31 are urged inward with respect to each other with increased force. Therefore, the electrode pads 2, placed on the gas sensing element 1 at the base end portion 1b thereof, are applied with large forces from the contact terminals 31 in directions perpendicular to the surface 23. Under such a state, the contact terminals 31 slide on the surfaces 23 of the electrode pads 2 accompanied with the occurrence of increasing friction.

Further, the electrode pads 2 of the gas sensing element 1 may be formed by printing electrically conductive paste on the base end portion 1b of the gas sensing element 1 in layers for the electrode pads 2 to be formed and subsequently firing the electrically conductive paste layers. During such formation of the electrode pads 2, first and second electrically conductive pastes of different compositions are employed to form the uppermost layer 21 and the lowermost layer 22, respectively.

More particularly, the first electrically conductive paste for the uppermost layer 21 is selected to have a larger noble metal (platinum) content than that of the second electrically conductive paste for the lowermost layer 22. Then, the first and second electrically conductive pastes of such two kinds are sequentially printed in piles on the surface 11a of the ceramic substrate 11. That is, first the second electrically conductive paste for the lowermost layer 22 is printed over the surface 11a of the ceramic substrate 11 and, thereafter, the first electrically conductive paste for the uppermost layer 21 is printed over the second electrically conductive paste for the lowermost layer 22. In an alternative, the second electrically conductive paste for the lowermost layer 22 may be printed and then once the second electrically conductive paste is fired, after which the first electrically conductive paste for the uppermost layer 21 is printed and then fired. In another alternative, the first and second electrically conductive pastes of two kinds may be printed and then fired at once.

Next, advantageous effects of the gas sensing element 1 of the present embodiment will be described below.

With the gas sensing element 1 of the present embodiment, each of the electrode pads 22 has the surface region 201 having noble metal content greater than noble metal content of the bonding region 202. This enables the surface region 201 to have increased noble metal content with resultant improvement in smoothing capability of the contact surface 23 to be brought into contact with the contact terminals 31. This results in a reduction in a frictional force between the contact terminal 31 and the contact surface 23 to be held in contact therewith. This results in capability of suppressing the occurrence of damage to the electrode pads 2 when causing the contact terminals 31 to slide on the surface 23 of the electrode pads 2.

Further, since the surface region 201 has noble metal content greater than that of the bonding region 202, the bonding region 202 can have an increased ceramic content. Therefore, ceramic components of the bonding region 202 can be bonded to ceramics components of the ceramic substrate 11 to provide an increased bonding force between the electrode pads 2 and the ceramic substrate 11. This provides a capability of preventing the electrode pads 2 from peeling off from the ceramic substrate 11 when causing the contact terminals 31 to slide on the surfaces 23 of the electrode pads 2.

As a result this can provide increased connecting reliability between the electrode pads 2 and the contact terminals 31.

Further, each electrode pad 2 takes the form of the layered structure composed of two or more layers having noble metal contents different from each other. In addition, the uppermost layer 21, involving the surface region 201, has noble metal content greater than that of the lowermost layer involving the bonding region 202. This enables noble metal content of the surface region 201 to increase to be greater than that of the bonding region 202 in an easy and reliable fashion, thereby making it possible to increase connecting reliability of the electrode pad 2 in an easy and reliable fashion.

Further, with the uppermost layer 21 selected to have the thickness of 3 μm or more and more preferably 4 μm or more and the lowermost layer 22 selected to have the thickness of 12 μm or more, the electrode pads 2 can have further increased strengths. That is, permitting the uppermost layer 21 to have the thickness of 4 μm or more results in a capability of adequately ensuring the surfaces 23 of the electrode pads 22 to have adequate smoothing property while adequately achieving a reduction in frictional resistance between the electrode pads 2 and the contact terminals 31. In addition, causing the lowermost layer 22 to have the thickness of 12 μm or more results in a capability of ensuring an adequate bonding force between the electrode pads 2 and the ceramic substrate 11 while effectively preventing the electrode pads 2 from peeling from the ceramic substrate 11. Moreover, the lowermost layer 22 may preferably have a thickness of 20 μm or more.

Further, since noble metal and ceramics, forming the electrode pads 2, include platinum and alumina, respectively, the electrode pads 2 can ensure adequately increased electric conductivity, while enabling the electrode pads 2 to have adequately increased bonding property with respect to the ceramic substrate 11.

Furthermore, the surface region 201 has 1 wt % or less by weight of ceramics based on noble metal and the bonding region 202 has 30 wt % or less by weight of ceramics based on noble metal. This enables the electrode pads 2 to have increased strengths.

Moreover, causing the bonding region 202 to have 12 to 30 wt % by weight of ceramics based on noble metal enables the electrode pads 2 to be further effectively bonded to the ceramic substrate 11 with increased bonding strengths, while ensuring the electrode pads 2 to have adequate electrically conductive property.

As set forth above, with this example, it becomes possible to provide the gas sensing element having the electrode pads with excellent connecting reliability.

### Example 2

This example was executed for checking strengths of the electrode pads of the gas sensing element as shown in FIGS. 4A, 4B and 4C and Tables 1 and 2.

First, gas sensing elements were prepared in different characteristics with various changes being made on layered structures of the electrode pads and mixing ratios of alumina. These gas sensing elements had the same structures as that of the gas sensing element 1, shown with reference to example 1, respectively, except for the layered structures of the electrode pads.

Further, electrode pads, obtained with materials composed of platinum mixed with alumina to be formed in single layered structures, were prepared as standards 1 to 3. In addition, gas sensing elements formed in two layered structures having the uppermost layers 21 and the lowermost layers 22 with different mixing ratios of alumina, were prepared as standards 4 to 25. Moreover, weight ratios of alumina based on platinum contained in the respective layers were changed.

Furthermore, each of the electrode pads had a total thickness of 20 μm and the uppermost layer 201 and the lowermost layer 202 had a total thickness fixed at a value of 20 μm for the standards 4 to 25 with respective thickness being selected to have arbitrary values.

Moreover, 20 pieces of gas sensing elements were prepared as respective standards.

Next, tests were conducted to check strengths of the electrode pads using the test pieces described above.

As shown in FIGS. 4A, 4B and 4C, during each of the tests, the contact terminal 31 was moved in a direction as shown by an arrow S in FIG. 4A in abutting engagement with the electrode pad 2, formed on the ceramic substrate 11, to slide on the electrode pad 2 along a longitudinal direction of the gas sensing element 1. As shown in FIG. 4A, more particularly, the contact terminal 31, acting as a spring terminal, was moved from a base end portion 11b of the ceramic substrate 11 toward the electrode pad 2. Then, as shown in FIG. 4B, the abutment portion 311, extending in parallel to the longitudinal direction of the gas sensing element 1 and formed on the folded spring end 31a in a convexed shape downwardly protruding toward the electrode pad 2, was brought into abutting contact with the surface 23 of the electrode pad 2 for sliding movement. When this takes place, the abutment portion 311 of the contact terminal 31 applied a given load F to the surface 23 of the electrode pad 2.

Under such a state, as shown in FIG. 4C, the contact terminal 31 was caused to move on the electrode pad 2 in sliding contact therewith to an area in close proximity to a center of the electrode pad 2 and the observation was made to check the degree of scraping caused on the electrode pad 2. That is, after the sliding movement of the contact terminal 31, the electrode pad 2 was observed to check if the ceramic substrate 11 was exposed. Then, the existence of such an exposure of the ceramic substrate 11 was regarded to be defective as labelled “NG”. All of the twenty test pieces, appeared in the absence of such an exposure of the ceramic substrate 11 even if applied with the load F of 20 N, were regarded to be acceptable “A” (in a best quality). Further, all of the twenty test pieces, appeared in the absence of such an exposure of the ceramic substrate 11 even if applied with the load F of 10 N, were regarded to be acceptable “B” (in a second quality grade). Furthermore, all of the twenty test pieces, appeared in the absence of such an exposure of the ceramic substrate 11 even if applied with the load F of 5 N, were regarded to be acceptable “C” (in a third quality grade). To this end, tests were conducted on samples of all the twenty test pieces for respective standards, thereby checking the number of defective pieces involved in the twenty test pieces of the respective samples. Results are indicated on Tables 1 and 2.

TABLE 1

| | | | Number of Defective | | | | |
|---|---|---|---|---|---|---|---|
| | | | Test Pieces | | | | |
| STD | Film | Al₂O₃/Pt | Among 20 Pieces | | | | |
| No. | Structure | (wt %) | 5N | 10N | 15N | 20N | Evalua. |
| 1 | Single | 1 | 20 | 20 | 20 | 20 | NG |
| | Layer | | | | | | |
| 2 | Single | 6 | 10 | 15 | 18 | 20 | NG |
| | Layer | | | | | | |
| 3 | Single | 12 | 0 | 12 | 16 | 20 | C |
| | Layer | | | | | | |
| 4 | Uppermost | 0 | 0 | 0 | 1 | 5 | B |
| | Layer | | | | | | |
| | Lowermost | 6 | | | | | |
| | Layer | | | | | | |
| 5 | Uppermost | 0 | 0 | 0 | 0 | 0 | A |
| | Layer | | | | | | |
| | Lowermost | 12 | | | | | |
| | Layer | | | | | | |
| 6 | Uppermost | 0 | 0 | 0 | 0 | 0 | A |
| | Layer | | | | | | |
| | Lowermost | 20 | | | | | |
| | Layer | | | | | | |
| 7 | Uppermost | 0 | 0 | 0 | 0 | 0 | A |
| | Layer | | | | | | |
| | Lowermost | 30 | | | | | |
| | Layer | | | | | | |
| 8 | Uppermost | 1 | 0 | 0 | 2 | 6 | B |
| | Layer | | | | | | |
| | Lowermost | 6 | | | | | |
| | Layer | | | | | | |
| 9 | Uppermost | 1 | 0 | 0 | 0 | 1 | A |
| | Layer | | | | | | |
| | Lowermost | 12 | | | | | |
| | Layer | | | | | | |
| 10 | Uppermost | 1 | 0 | 0 | 0 | 0 | A |
| | Layer | | | | | | |
| | Lowermost | 20 | | | | | |
| | Layer | | | | | | |
| 11 | Uppermost | 1 | 0 | 0 | 0 | 0 | A |
| | Layer | | | | | | |
| | Lowermost | 30 | | | | | |
| | Layer | | | | | | |

TABLE 2

| | | | Number of Defective | | | | |
|---|---|---|---|---|---|---|---|
| | | | Test Pieces | | | | |
| STD | Film | Al₂O₃/Pt | Among 20 Pieces | | | | |
| No. | Structure | (wt %) | 5N | 10N | 15N | 20N | Evalua. |
| 12 | Uppermost | 30 | 19 | 20 | 20 | 20 | NG |
| | Layer | | | | | | |
| | Lowermost | 0 | | | | | |
| | Layer | | | | | | |
| 13 | Uppermost | 30 | 18 | 19 | 20 | 20 | NG |
| | Layer | | | | | | |
| | Lowermost | 1 | | | | | |
| | Layer | | | | | | |
| 14 | Uppermost | 30 | 14 | 16 | 18 | 19 | NG |
| | Layer | | | | | | |
| | Lowermost | 6 | | | | | |
| | Layer | | | | | | |
| 15 | Uppermost | 30 | 11 | 13 | 15 | 17 | NG |
| | Layer | | | | | | |
| | Lowermost | 12 | | | | | |
| | Layer | | | | | | |
| 16 | Uppermost | 30 | 10 | 12 | 14 | 16 | NG |
| | Layer | | | | | | |
| | Lowermost | 20 | | | | | |
| | Layer | | | | | | |
| 17 | Uppermost | 20 | 20 | 20 | 20 | 20 | NG |
| | Layer | | | | | | |
| | Lowermost | 0 | | | | | |
| | Layer | | | | | | |
| 18 | Uppermost | 20 | 18 | 20 | 20 | 20 | NG |
| | Layer | | | | | | |
| | Lowermost | 1 | | | | | |
| | Layer | | | | | | |
| 19 | Uppermost | 20 | 15 | 17 | 19 | 20 | NG |
| | Layer | | | | | | |
| | Lowermost | 6 | | | | | |
| | Layer | | | | | | |
| 20 | Uppermost | 20 | 12 | 14 | 17 | 18 | NG |
| | Layer | | | | | | |
| | Lowermost | 12 | | | | | |
| | Layer | | | | | | |
| 21 | Uppermost | 12 | 20 | 20 | 20 | 20 | NG |
| | Layer | | | | | | |
| | Lowermost | 0 | | | | | |
| | Layer | | | | | | |
| 22 | Uppermost | 12 | 19 | 20 | 20 | 20 | NG |
| | Layer | | | | | | |
| | Lowermost | 1 | | | | | |
| | Layer | | | | | | |
| 23 | Uppermost | 12 | 17 | 19 | 20 | 20 | NG |
| | Layer | | | | | | |
| | Lowermost | 6 | | | | | |
| | Layer | | | | | | |
| 24 | Uppermost | 6 | 20 | 20 | 20 | 20 | NG |
| | Layer | | | | | | |
| | Lowermost | 0 | | | | | |
| | Layer | | | | | | |
| 25 | Uppermost | 6 | 20 | 20 | 20 | 20 | NG |
| | Layer | | | | | | |
| | Lowermost | 1 | | | | | |
| | Layer | | | | | | |

As will be understood from Tables 1 and 2, the standards 1 to 3, having the electrode pads each formed in a single layer, had extremely defective results when applied with the load F of 10 N in comparison to the other condition. Meanwhile, it is turned out that with the electrode pads each formed in the two layers (see STD Nos. 4 to 11 in Table 1), the number of the test pieces in defective results were less than that of the test pieces having the electrode pads in the single layers. As will be understood from Table 2, however, even with the test pieces having the electrode pads formed in two layers, respectively, it is hard to say that the electrode pads have sufficiently improved strengths under a situation (see STD Nos. 12 to 25) where the uppermost layer 21 has a greater ceramics (alumina) blending ratio (with a lower metal (platinum) blending ratio) than that of the lowermost layer 22.

As the results of STD Nos. 4 to 11 in Table 1, next, it is understood that the uppermost layer 21 may preferably have the ceramics (alumina) blending ratio of 1 wt % or less based on noble metal (platinum) by weight and that the lowermost layer 22 may preferably have the ceramics (alumina) blending ratio ranging from 6 to 30 wt % or less based on noble metal (platinum) by weight.

For that matter, it is understood that the electrode pads can have further increased strengths provided that the uppermost layer 21 has the ceramics (alumina) blending ratio of 1 wt % or less by weight and the lowermost layer 22 has the ceramics (alumina) blending ratio ranging from 12 to 30 wt % or less by weight (see STD Nos. 5 to 7 and 9 to 11 in Table 1).

From the results set forth above, it is understood that the electrode pads can have adequately improved strengths provided that the uppermost layer 21 has 1 wt % or less of ceramics (alumina) by weight based on noble metal (platinum) and the lowermost layer 22 has 6 to 30 wt % of ceramics (alumina) by weight based on noble metal (platinum) (see STD Nos. 4 to 11 in Table 1). In addition, the electrode pads can have further improved strengths provided that the lowermost layer 22 has 12 to 30 wt % of ceramics (alumina) by weight based on noble metal (platinum) (see STD Nos. 5 to 7 and 9 to 11 in Table 1).

### Example 3

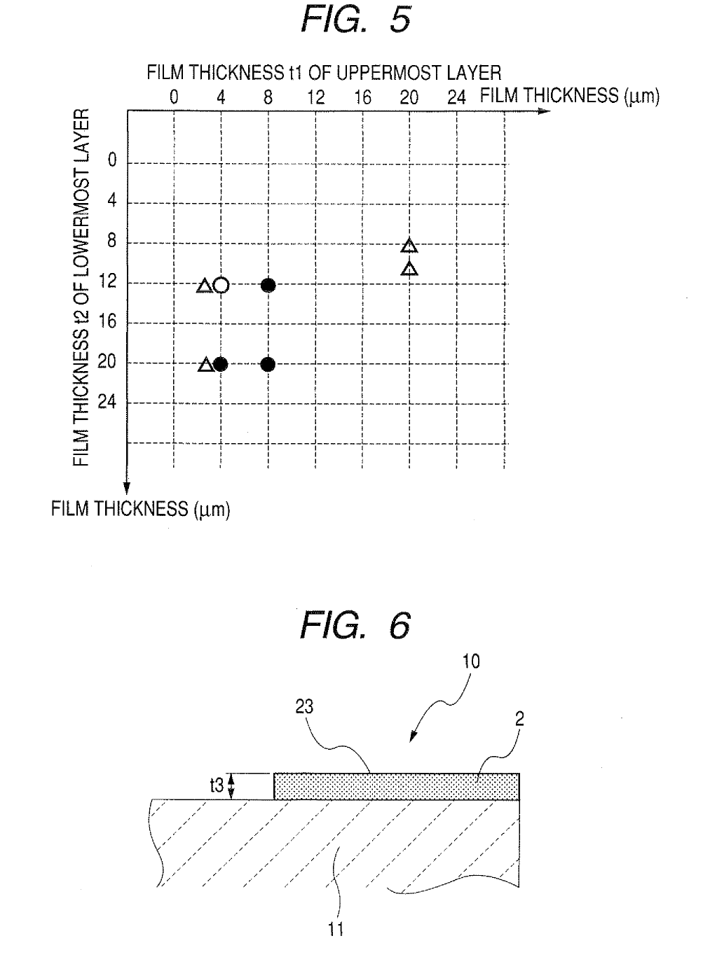

This example was conducted to check the relationship between the film thickness between the uppermost layer 21 and the lowermost layer 22 of each electrode pad 2 forming the gas sensing element 1 indicated in example 1 and strength of each electrode pad as shown in Table 3 and FIG. 5.

That is, twenty test pieces were prepared for sample nos. 1 to 8, respectively, in structures having the uppermost layer 21 with film thickness formed in variation ranging from 3 to 20 μm and the lowermost layer 22 with film thickness formed in variation ranging from 8 to 20 μm. With the test pieces for the sample nos. 1 to 8, the uppermost layer 21 and the lowermost layer 22 had contents of Al₂O₃ in arbitrary values in terms of Pt.

Further, the test pieces for respective samples were subjected to the same scraping tests as those of example 2.

Results are indicated in Table 3 and FIG. 5. Table 3 indicates the number of the test pieces with defects for respective samples. Further, FIG. 5 shows a graph in which a label “” represents that all of the twenty test pieces appeared to be acceptable in the absence of defective results even if applied with the load F of 20 N; a label “∘” represents that all of the twenty test pieces appeared to be acceptable in the absence of defective results even if applied with the load F of 10 N; a label “Δ” represents that all of the twenty test pieces appeared to be acceptable in the absence of defective results even if applied with the load F of 5 N.

TABLE 3

| | | | Number of Defective | | | | |
|---|---|---|---|---|---|---|---|
| | | | Test Pieces | | | | |
| STD | Film | Al₂O₃/Pt | Among 20 Pieces | | | | |
| No. | Structure | (wt %) | 5N | 10N | 15N | 20N | Evalua. |
| 1 | Uppermost | 20 | 0 | 4 | 14 | 17 | Δ |
| | Layer | | | | | | |
| | Lowermost | 8 | | | | | |
| | Layer | | | | | | |
| 2 | Uppermost | 20 | 0 | 3 | 11 | 15 | Δ |
| | Layer | | | | | | |
| | Lowermost | 10 | | | | | |
| | Layer | | | | | | |
| 3 | Uppermost | 3 | 0 | 4 | 3 | 17 | Δ |
| | Layer | | | | | | |
| | Lowermost | 12 | | | | | |
| | Layer | | | | | | |
| 4 | Uppermost | 4 | 0 | 0 | 6 | 12 | ∘ |
| | Layer | | | | | | |
| | Lowermost | 12 | | | | | |
| | Layer | | | | | | |
| 5 | Uppermost | 8 | 0 | 0 | 0 | 0 | • |
| | Layer | | | | | | |
| | Lowermost | 12 | | | | | |
| | Layer | | | | | | |
| 6 | Uppermost | 3 | 0 | 1 | 4 | 5 | Δ |
| | Layer | | | | | | |
| | Lowermost | 20 | | | | | |
| | Layer | | | | | | |
| 7 | Uppermost | 4 | 0 | 0 | 0 | 0 | • |
| | Layer | | | | | | |
| | Lowermost | 20 | | | | | |
| | Layer | | | | | | |
| 8 | Uppermost | 8 | 0 | 0 | 0 | 0 | • |
| | Layer | | | | | | |
| | Lowermost | 30 | | | | | |
| | Layer | | | | | | |

As will be understood from Table 3 and FIG. 5, no defects are encountered in the test pieces even if applied with the load F of 10 N regardless of the content of Al₂O₃ with respect to Pt only in cases where the uppermost layer 21 has a film thickness of 4 μm or more and the lowermost layer 22 has a film thickness of 12 μm or more (see STD Nos. 4, 5, 7 and 8 in Table 3). With the electrode pads 2 having total thicknesses exceeding a value of 30 μm, disadvantages appear with an increase in cost and, hence, the test have been conducted under a condition with the electrode pads 2 having the total thicknesses below the value of 30 μm.

As the results set forth above, it will be understood that the electrode pads can have adequately increased strengths regardless of the content of Al₂O₃ with respect to Pt provided that the uppermost layer 21 has the film thickness of 4 μm or more and the lowermost layer 22 has the film thickness of 12 μm or more.

### Reference Example 1

This reference example is directed to a gas sensing element 10 formed in a structure including electrode pads 2 each made of mixed material containing noble metal and glass component.

Each of the electrode pads 2 had 0.1 wt % or more by weight of glass component based on noble metal.

Further, each of the electrode pads 2 had a thickness t3 in a range from 12 to 32 μm.

The electrode pads 2 contained platinum as noble metal and alumina as ceramics. Also, the electrode pads 2 can contain glass component having a principal component of silicon oxide (SiO₂) to which magnesium oxide (MgO) and alumina (Al₂O₃) may be added.

Further, each of the electrode pads 2 contained ceramics at a blending ratio of 30 wt % or less based on noble metal and, more preferably, in a range from 6 to 12 wt %.

Furthermore, in contrast to the structure of the electrode pads in example 1, the electrode pads 2 of this reference example can be formed in single layers, respectively. Others are similar to those of example 1.

With the gas sensing element 1 of the present example, the electrode pads 2 are made of mixed material containing noble metal and ceramics. That is, the electrode pads 2 contain glass component. This enables the electrode pads 2 to have increased strengths with increased hardness. Therefore, when causing the contact terminals 31 to slide on the surfaces 23 of the electrode pads, no damage occurs on the electrode pads 2.

This results in an increase in connecting reliability between the electrode pads 2 and the contact terminals 31.

Further, each of the electrode pads 2 has 0.1 wt % or more of glass component by weight based on noble metal. This enables the electrode pads 2 to have increased sintering strengths with improved hardness.

Furthermore, each of the electrode pads 2 has a thickness of 12 μm or more, thereby ensuring the electrode pads 2 to have adequate strength.

As set forth above, this example makes it possible to provide the gas sensing element 10 having the electrode pads 2 with excellent connecting reliability.

In other respect, this example has the same advantageous effects as those of example 1.

### Reference Example 2

As indicated on Table 4, this example is directed to a case of checking the relationship between the amount of added glass component and film thickness of the electrode pad 2 and strength of the electrode pad 2 of the gas sensing element 10 indicated on reference example 2.

That is, six test pieces, show in Table 4, were prepared upon varying the amount of added glass component by weight based on noble metal platinum) in a range from 0 to 10 wt % while varying the film thickness of the electrode pad 2 in a range from 8 to 32 μm. Also, in any cases, the amount of ceramics (alumina) added to each of the test pieces was 12 wt % on the basis of noble metal (platinum).

Ten specimens were prepared for each standard with scraping tests being conducted on respective specimens in the same manner as that of example 2.

In Table 4, a symbol “G” represents that the electrode pad 2 has resulted in a good result and another symbol “N” represents that the electrode pad 2 has resulted in a bad result.

TABLE 4

| | | | Film | | | | |
|---|---|---|---|---|---|---|---|
| STD | Al₂O₃/Pt | Glass | Thickness | Load F (N) | | | |
| No. | (wt %) | (wt %) | (μm) | 5 | 10 | 15 | 20 |
| 1 | 12 | 0 | 20 | GGGGG | GGGGG | GGNNN | |
| | | | | GGGGG | NNNNN | NNNNN | |
| 2 | 12 | 0.1 | 8 | GGGGG | GGGGG | GGGGN | NNNNN |
| | | | | GGGGN | GNNNN | NNNNN | NNNNN |
| 3 | 12 | 0.1 | 12 | GGGGG | GGGGG | GGGGG | GGGNN |
| | | | | GGGGG | GGGGG | GGNNN | NNNNN |
| 4 | 12 | 0.1 | 20 | GGGGG | GGGGG | GGGGG | GGGGG |
| | | | | GGGGG | GGGGG | GGGGG | NNNNN |
| 5 | 12 | 0.1 | 32 | GGGGG | GGGGG | GGGGG | GGGGG |
| | | | | GGGGG | GGGGG | GGGGG | GGGGG |
| 6 | 12 | 10 | 20 | GGGGG | GGGGG | GGGGG | GGGGG |
| | | | | GGGGG | GGGGG | GGGGG | GGGGG |

As will be clear from Table 4, those of which defects did not appear even when subjected to the scraping tests with the load F of 10 N included the specimens in which the amount of glass being added was 0.1 wt % or more and the electrode pad 2 had the film thickness of 12 μm or more.

From the results set forth above, the amount of glass being added may preferably lay in a value of 0.1 wt % or more on the basis of noble metal and the electro de pad 2 may preferably have the film thickness of 12 μm or more.

Further, example 1 may be implemented in a modified form with the electrode pads 2 formed in a structure of three layers or more. In another alternative, the electrode pad 2 may not take the form of the layered structure and, instead thereof, the electrode pad 2 may take a gradation structure with noble metal having a content gradually varying in a thickness direction.

Furthermore, example 1 and reference example 1 may be combined in structure. For instance, adding the glass component onto at least one of the uppermost layer 21 and the lowermost layer 22 in example 1 results in the formation of the electrode pad 2 with a further increased strength.

While the present invention has been described in detail with reference to the specific embodiment, it will be appreciated by those skilled in the art that the present invention is not limited to the present embodiment of such a structure and various modifications and alternatives to those details could be developed in light of the overall teachings of the disclosure. Accordingly, the particular arrangement disclosed is meant to be illustrative only and not limited to the scope of the present invention.

What is claimed is:

1. A gas sensing element comprising:
a ceramic substrate;
electrode pads formed on the ceramic substrate on one surface thereof and adapted to be brought into abutting contact with contact terminals on abutment portions formed thereon in convexed shapes, respectively, for electrical connections thereto;
each of the electrode pads being made of mixed material including noble metal and ceramics; and
the electrode pads having bonding regions tightly bonded to the surface of the ceramic substrate and surface regions providing surfaces available to be brought into contact with the contact terminals, respectively, wherein the surface regions are at least partially composed of a noble metal and have a greater noble metal content than that in the bonding regions.

2. The gas sensing element according to claim 1, wherein:
the electrode pads have layered structures each having two or more layers having the contents of noble metal in amounts different from each other; and
each of the electrode pads has an uppermost layer, involving the surface region, and a lowermost layer, involving the bonding region, wherein the uppermost layer has noble metal content greater than that of the lowermost layer.

3. The gas sensing element according to claim 2, wherein:
the uppermost layer has a thickness of 4 μm or more and the lowermost layer has a thickness of 12 μm or more.

4. The gas sensing element according to claim 2, wherein:
noble metal includes platinum and the ceramics includes alumina.

5. The gas sensing element according to claim 2, wherein:
the surface region has 1 wt % or less of ceramics by weight based on noble metal and the bonding region has 30 wt % or less of ceramics by weight based on noble metal.

6. The gas sensing element according to claim 5, wherein:
the bonding region has 12 to 30 wt % of ceramics by weight based on noble metal.

7. The gas sensing element according to claim 1, wherein:
the electrode pads are made of the mixed material including noble metal and ceramics and, in addition, a glass component.

8. The gas sensing element according to claim 7, wherein:
the mixed material of each of the electrode pads includes 0.1 wt % or more of the glass component by weight based on noble metal.

9. The gas sensing element according to claim 7, wherein:
each of the electrode pads has a thickness of 12 μm or more.

10. A gas sensor incorporating the gas sensing element recited in claim 1.
